(19) United States
(12) Patent Application Publication
(10) Pub. No.: US 2024/0403708 A1
(43) Pub. Date: Dec. 5, 2024

(54) MACHINE LEARNING METHOD AND INFORMATION PROCESSING APPARATUS

(71) Applicant: Fujitsu Limited, Kawasaki-shi (JP)

(72) Inventor: Thang Duy Dang, Yokohama (JP)

(73) Assignee: Fujitsu Limited, Kawasaki-shi (JP)

(21) Appl. No.: 18/633,583

(22) Filed: Apr. 12, 2024

(30) Foreign Application Priority Data
May 29, 2023 (JP) 2023-087740

(51) Int. Cl. G06N 20/00

(52) U.S. Cl. CPC G06N 20/00

(57) ABSTRACT

An information processing apparatus enters a plurality of data samples individually to a machine learning model and extracts a plurality of features from the machine learning model. The information processing apparatus normalizes the plurality of features to a plurality of normalized features. The information processing apparatus selects, based on the plurality of normalized features, at least one data sample, which is part of the plurality of data samples, from the plurality of data samples. The information processing apparatus trains the machine learning model by using the at least one data sample.

### CROSS-REFERENCE TO RELATED APPLICATION

This application is based upon and claims the benefit of priority of the prior Japanese Patent Application No. 2023-087740, filed on May 29, 2023, the entire contents of which are incorporated herein by reference.

### FIELD

The embodiments discussed herein relate to a machine learning method and an information processing apparatus.

### BACKGROUND

There are cases in which a computer generates predicted data corresponding to an objective variable from input data corresponding to an explanatory variable by using a trained machine learning model. There are cases in which a computer trains a machine learning model through machine learning by using a plurality of data samples, in each of which input data corresponding to an explanatory variable and a correct label corresponding to an objective variable are associated with each other.

There are cases in which a machine learning model calculates features of input data from the input data, and generates predicted data by using the calculated features. There are cases in which a neural network is used to calculate these features.

In addition, there are cases in which a machine learning model is used to predict the result of a computer simulation needing a large calculation amount within a short time. The machine learning model may be referred to as a surrogate model. For example, there has been proposed a structural analysis simulation for predicting a displacement vector from a stiffness matrix and a force vector by using a graph convolutional neural network.

Japanese Laid-open Patent Publication No. 2023-9904

### SUMMARY

According to one aspect, there is provided a non-transitory computer-readable recording medium storing therein a computer program that causes a computer to execute a process including: entering a plurality of data samples individually to a machine learning model and extracting a plurality of features of each of the data samples from the machine learning model; normalizing the plurality of features to a plurality of normalized features that fall within a certain numerical value range; selecting, based on the plurality of normalized features, at least one data sample, which is part of the plurality of data samples, from the plurality of data samples; and training the machine learning model by using the at least one data sample.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing apparatus according to a first embodiment;

FIG. 2 illustrates a hardware example of an information processing apparatus according to a second embodiment;

FIG. 3 illustrates a usage example of a machine learning model that predicts the result of a quantum chemical calculation;

FIG. 4 illustrates an update example of a feature vector based on a graph structure;

FIG. 5 illustrates a structure example of the machine learning model;

FIG. 6 illustrates a structure example of a molecular dataset;

FIG. 7 illustrates an example of sample selection in machine learning;

FIG. 8 illustrates an example of normalization of feature vectors;

FIG. 9 is a graph illustrating examples of average errors of machine learning models;

FIG. 10 is a block diagram illustrating a functional example of the information processing apparatus;

FIG. 11 is a flowchart illustrating a procedure example of the machine learning; and

FIG. 12 is a flowchart illustrating a procedure example of the sample selection.

### DESCRIPTION OF EMBODIMENTS

When a dataset includes many data samples, training a machine learning model by using all the data samples could increase the load of the computer and extend the training time. One conceivable solution to this problem is to allow the computer to select some of the data samples and to train the machine learning model by using the selected data samples.

In this case, how some of the data samples are selected is important. Even if the same number of data samples is used, a trained machine learning model could indicate different prediction accuracies, depending on the data samples selected.

Hereinafter, the embodiments will be described with reference to the drawings.

### First Embodiment

A first embodiment will be described.

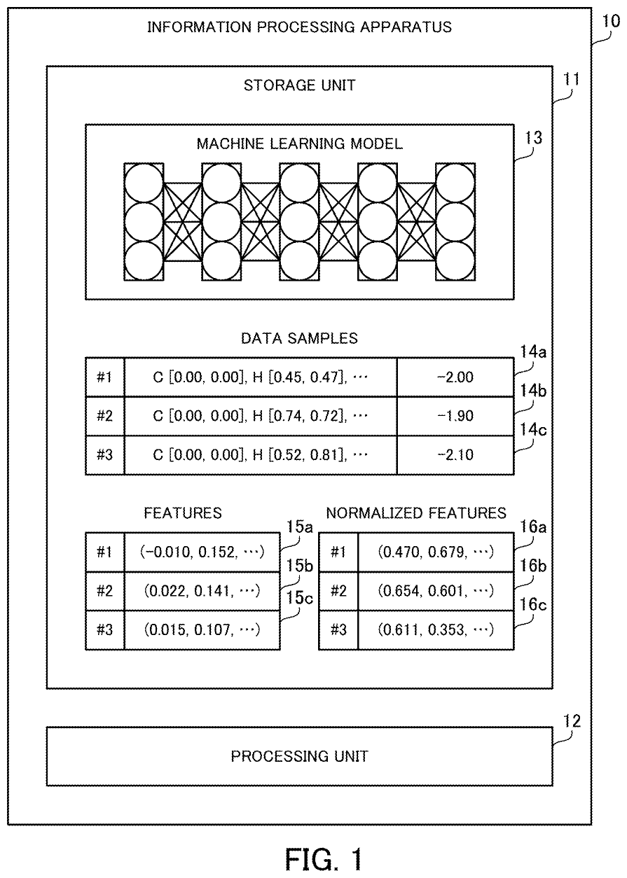

FIG. 1 illustrates an information processing apparatus according to a first embodiment.

This information processing apparatus 10 according to the first embodiment executes machine learning for training a machine learning model by using training data. The machine learning model may be a surrogate model that predicts the result of a quantum chemical calculation. The information processing apparatus 10 may be a client apparatus or a server apparatus. The information processing apparatus 10 may be referred to as a computer or a machine learning apparatus.

The information processing apparatus 10 includes a storage unit 11 and a processing unit 12. The storage unit 11 may be a volatile semiconductor memory such as a random access memory (RAM). The storage unit 11 may be a non-volatile storage such as a hard disk drive (HDD) or a flash memory.

The processing unit 12 is, for example, a processor such as a central processing unit (CPU), a graphics processing unit (GPU), or a digital signal processor (DSP). The processing unit 12 may include an electronic circuit such as an application specific integrated circuit (ASIC) or a field programmable gate array (FPGA). For example, the processor executes a program stored in a memory such as a RAM (for example, the storage unit 11). A group of processors may be referred to as a multiprocessor or simply a “processor”.

The storage unit 11 stores a machine learning model 13. The machine learning model 13 calculates features from input data and generates predicted data from the calculated features. The machine learning model 13 may be a neural network or a graph neural network (GNN). Based on an inter-node connection relationship indicated by graph data including a plurality of nodes and a plurality of edges, the graph neural network updates the feature of each of the plurality of nodes. The feature of a node is updated by using the features of its neighboring nodes. Such a graph neural network may be referred to as a message passing neural network (MPNN).

The machine learning model 13 includes parameters whose parameter values are optimized through machine learning. For example, the parameters are weights included in the neural network. When the machine learning model 13 includes a graph neural network, a function that updates the feature of a node by using the features of its neighboring nodes may include such a parameter.

The machine learning model 13 may be a surrogate model that predicts molecular energy, which is conventionally calculated by a quantum chemical calculation based on a density functional theory (DFT) or the like, from molecular data indicating a molecular structure. The density functional theory calculates molecular ground state energy from an electron density. A quantum chemical simulation that directly executes the density functional theory needs a large calculation amount. A surrogate model reduces the calculation amount of the quantum chemical simulation. For example, the molecular structure is defined by graph data including nodes representing atoms and edges representing an inter-atom connection relationship. For example, the surrogate model is given nuclear charges as the initial values of the features of the nodes, updates the features of the nodes based on the graph structure, and calculates the energy from the features.

The storage unit 11 stores a plurality of data samples such as data samples 14a, 14b, and 14c. Each of the plurality of data samples includes input data entered to the machine learning model 13. Each of the plurality of data samples may include a correct label indicating a correct answer compared with the output of the machine learning model 13. For example, each of the data samples 14a, 14b, and 14c includes a molecular structure and molecular energy. For example, the individual molecular structure is defined by the coordinates of the atoms included in a molecule and by the elements, which indicate the kinds of the atoms.

The processing unit 12 trains the machine learning model 13 by using some of the plurality of data samples. The processing unit 12 selects the data samples used for the machine learning in accordance with the following method. The selection of the data samples may be based on the concept of so-called active learning. Before the data samples are selected, the machine learning model 13 has been temporarily trained in advance. For example, the parameter values included in the machine learning model 13 have been updated in advance based on a small number of data samples.

The processing unit 12 enters each of the plurality of data samples to the machine learning model 13, and extracts a plurality of features of the respective data samples from the machine learning model 13. For example, the processing unit 12 extracts features 15a, 15b, and 15c of the respective data samples 14a, 14b, and 14c from the machine learning model 13.

The extracted features are, for example, those that are close to the output side of the machine learning model 13 and that are not the predicted data outputted by the machine learning model 13. If the machine learning model 13 includes a graph neural network, the extracted features are, for example, those of the individual nodes that are updated by the graph neural network and that are obtained immediately before an aggregation process of aggregating these features and generating predicted data. The extracted features may be numerical vectors including numerical values of a plurality of dimensions.

The processing unit 12 normalizes the plurality of extracted features to a plurality of normalized features, which fall within a certain numerical value range. For example, the processing unit 12 normalizes the features 15a, 15b, and 15c to normalized features 16a, 16b, and 16c. The certain numerical value range is, for example, a range from 0 to 1, inclusive. The processing unit 12 may execute scale adjustment by associating the minimum value of a plurality of features with 0, and the maximum value of the plurality of features with 1. If a feature is a vector, the processing unit 12 may execute the normalization per dimension. In this case, a correspondence relationship between a pre-normalization numerical value and a post-normalization numerical value is determined per dimension.

The processing unit 12 selects some of the plurality of data samples based on the plurality of normalized features. In this selection, it is preferable that the processing unit 12 select data samples whose normalized features are not similar to those of the other data samples. The number of data samples selected may be specified by the user or may be determined from the number of data samples of the population.

For example, the processing unit 12 transforms the plurality of normalized features into a plurality of principal component features, by executing principal component analysis (PCA) on the plurality of normalized features. The number of dimensions of the principal component features is less than that of the normalized features. Based on a distribution of the plurality of principal component features in the principal component space, the processing unit 12 selects a certain number of data samples whose principal component features are as dissimilar as possible to one another.

The processing unit 12 may calculate the distance between an individual pair of the plurality of normalized features or an individual pair of the plurality of principal component features, and may preferentially select data samples that are far from the other data samples. The processing unit 12 may classify the plurality of data samples into clusters in accordance with a clustering algorithm such as a k-means algorithm or hierarchical clustering, and may select representative data samples from each of the plurality of clusters.

The processing unit 12 trains the machine learning model 13 by using the selected data samples. The data samples that have not been selected are not used for the machine learning. For example, the processing unit 12 enters a selected data sample to the machine learning model 13, and calculates the error between the output of the machine learning model 13 and the corresponding correct label. The processing unit 12 updates the parameter values included in the machine learning model 13 such that the error will be minimized. The processing unit 12 may update the weights included in the neural network by executing backpropagation.

If no correct label has been added to the selected data sample, the processing unit 12 may request the user for a correct label. The processing unit 12 may repeat the training of the machine learning model 13 and the selection of a data sample a plurality of times. The processing unit 12 outputs the trained machine learning model 13. The processing unit 12 may store the machine learning model 13 in a non-volatile storage, may display the machine learning model 13 on a display apparatus, or may transmit the machine learning model 13 to another information processing apparatus. The processing unit 12 may execute a prediction process by using the trained machine learning model 13 or may measure the prediction accuracy of the machine learning model 13 by using test data.

As described above, the information processing apparatus 10 according to the first embodiment individually enters a plurality of data samples to the machine learning model 13 and extracts a plurality of features of the respective data samples from the machine learning model 13. The information processing apparatus 10 normalizes the plurality of features to a plurality of normalized features that fall within a certain numerical value range. The information processing apparatus 10 selects, based on the plurality of normalized features, at least one data sample, which is part of the plurality of data samples, from the plurality of data samples. The information processing apparatus 10 trains the machine learning model 13 by using the at least one data sample.

In this way, the information processing apparatus 10 narrows down the population to the data samples used for the machine learning. Thus, the load of the machine learning is reduced, and the training time is consequently shortened. In addition, with these selected samples, the machine learning model 13 achieves a better prediction accuracy, compared with a case in which all the miscellaneous data samples are used.

In addition, by using the normalized features obtained by normalizing the features calculated in the machine learning model 13, the data samples are narrowed down. Thus, data samples that are more likely to contribute to improvement in prediction accuracy are selected, and the prediction accuracy of the machine learning model 13 is consequently improved. In particular, because the features extracted from the machine learning model 13 are closer to the prediction result than the data samples are, the features are highly related to the prediction accuracy of the machine learning model 13. In addition, by normalizing the features, the features are represented by a unified scale, and the data sample selection accuracy is improved.

The machine learning model 13 may include a graph neural network that updates, based on a connection relationship among a plurality of nodes indicated by graph data, the feature of each of the plurality of nodes. The extracted features may be features that have passed through the graph neural network. The graph neural network defines non-linear transformation between input data and output data. Thus, the features that have passed through the graph neural network are more highly related to the final prediction result than those features that have not passed through the graph neural network are, and are used more suitably for selecting data samples. As a result, the data sample selection accuracy is improved, and the prediction accuracy of the machine learning model 13 is consequently improved.

In addition, the information processing apparatus 10 may transform a plurality of normalized features into a plurality of principal component features by executing principal component analysis, and may select a data sample based on the distance between an individual pair of the plurality of principal component features. In this way, the data sample selection accuracy is improved. In particular, by normalizing the features before executing the principal component analysis, the risk that some of the dimensions of the features become dominant and other dimensions are underestimated is reduced.

In addition, the machine learning model 13 may predict molecular energy from molecular data indicating a molecule including a plurality of atoms, and the plurality of features may be features calculated for the plurality of atoms. In this way, the machine learning model 13 is able to accurately predict the result of a quantum chemical simulation based on the density functional theory or the like, without executing a conventional algorithm. As a result, the load of the quantum chemical simulation is reduced, and the simulation time is consequently shortened. In addition, the accuracy in selecting the data samples corresponding to the molecular data is improved.

### Second Embodiment

Next, a second embodiment will be described.

An information processing apparatus 100 according to the second embodiment executes machine learning for training a machine learning model by using training data. The machine learning model according to the second embodiment is a surrogate model that predicts the result of a quantum chemical calculation using the density functional theory. The information processing apparatus 100 may be a client apparatus or a server apparatus. The information processing apparatus 100 may be referred to as a computer, a machine learning apparatus, or a simulation apparatus. The information processing apparatus 100 corresponds to the information processing apparatus 10 according to the first embodiment.

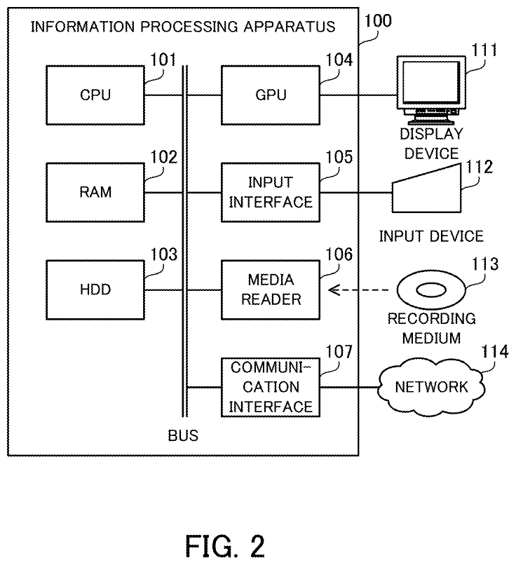

FIG. 2 illustrates a hardware example of the information processing apparatus according to the second embodiment.

The information processing apparatus 100 includes a CPU 101, a RAM 102, an HDD 103, a GPU 104, an input interface 105, a media reader 106, and a communication interface 107, all of which are connected to a bus. The CPU 101 corresponds to the processing unit 12 according to the first embodiment. The RAM 102 or the HDD 103 corresponds to the storage unit 11 according to the first embodiment.

The CPU 101 is a processor that executes program commands. The CPU 101 loads a program and data stored in the HDD 103 to the RAM 102, and executes the program. The information processing apparatus 100 may include a plurality of processors.

The RAM 102 is a volatile semiconductor memory that temporarily stores a program executed by the CPU 101 and data used for calculation by the CPU 101. The information processing apparatus 100 may include a different kind of volatile memory other than a RAM.

The HDD 103 is a non-volatile storage that stores an operating system (OS), middleware, software programs such as application software, and data. The information processing apparatus 100 may include a different kind of non-volatile storage, such as a flash memory or a solid state drive (SSD).

The GPU 104 performs image processing in coordination with the CPU 101 and outputs an image to a display device 111 connected to the information processing apparatus 100. Examples of the display device 111 include a cathode ray tube (CRT) display, a liquid crystal display, an organic electro-luminescence (EL) display, and a projector. A different kind of output device such as a printer may be connected to the information processing apparatus 100.

The GPU 104 may be used as a general purpose computing on graphics processing unit (GPGPU). The GPU 104 may execute a program in accordance with an instruction from the CPU 101. The information processing apparatus 100 may include, as a GPU memory, a volatile semiconductor memory other than the RAM 102.

The input interface 105 receives an input signal from an input device 112 connected to the information processing apparatus 100. Examples of the input device 112 include a mouse, a touch panel, and a keyboard. A plurality of input devices may be connected to the information processing apparatus 100.

The media reader 106 is a reading device that reads out a program and data recorded in a recording medium 113. Examples of the recording medium 113 include a magnetic disk, an optical disc, and a semiconductor memory. Examples of the magnetic disk include a flexible disk (FD) and an HDD. Examples of the optical disc include a compact disc (CD) and a digital versatile disc (DVD). The media reader 106 copies a program and data read out from the recording medium 113 to another recording medium such as the RAM 102 or the HDD 103. The read program may be executed by the CPU 101.

The recording medium 113 may be a portable recording medium and may be used for distribution of a program and data. The recording medium 113 and the HDD 103 may each be referred to as a computer-readable recording medium.

The communication interface 107 communicates with other information processing apparatuses via a network 114. The communication interface 107 may be a wired communication interface connected to a wired communication device such as a switch or a router. Alternatively, the communication interface 107 may be a wireless communication interface connected to a wireless communication device such as a base station or an access point.

The machine learning and the prediction process according to the second embodiment may be implemented on a dedicated server in a data center as application services. The machine learning and the prediction process according to the second embodiment may be applied to various industries such as for material development and catalyst selection.

Next, the machine learning model according to the second embodiment will be described.

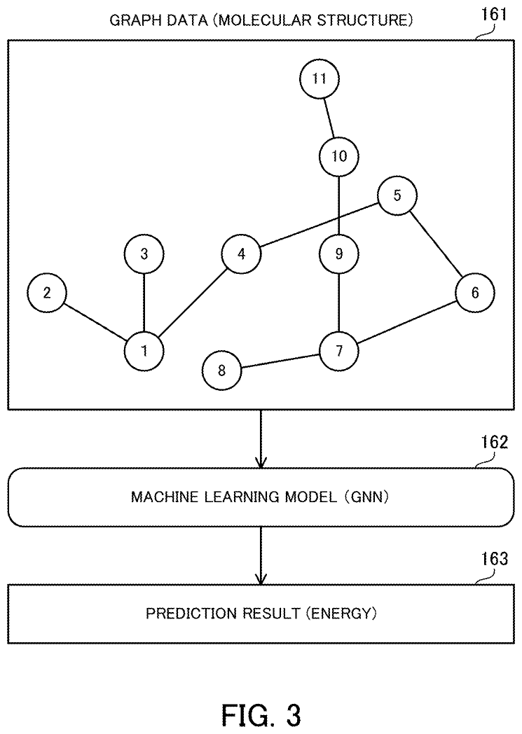

FIG. 3 illustrates a usage example of a machine learning model that predicts the result of a quantum chemical calculation.

To predict the result of a quantum chemical calculation, a graph data 161 indicating a molecular structure is given. The graph data 161 includes a plurality of nodes and a plurality of edges. An individual node included in the graph data 161 represents an atom. An individual edge included in the graph data 161 represents the connection between two atoms. Each node is specified by the coordinates of the location where an atom exists and by an element, which indicates the kind of this atom. In addition, each node is given a physical quantity for determining the initial value of its feature vector. For example, a nuclear charge is given as the physical quantity.

The information processing apparatus 100 enters the graph data 161 to a machine learning model 162. The machine learning model 162 is a graph neural network. The graph neural network may be referred to as “MPNN”. The machine learning model 162 updates the feature vector of a node based on the feature vector of its neighboring node and the edge vector given to the edge between the two nodes. The edge vector reflects the distance between the two nodes or the direction from one node to the other node. A feature vector may be referred to as a hidden state.

Functions for updating feature vectors include parameter values determined through machine learning. The machine learning model 162 updates the feature vector of an individual node a plurality of times, based on the feature vectors of its neighboring nodes. The machine learning model 162 aggregates the feature vectors of all the nodes, and generates and outputs a prediction result 163 as a scalar value. The prediction result 163 indicates the ground state energy of a molecule indicated by the graph data 161. The prediction result 163 corresponds to a predicted value of the result of a quantum chemical calculation using the density functional theory. By using the machine learning model 162, it is possible to predict the result of a quantum chemical calculation, without executing the quantum chemical calculation needing a heavy load.

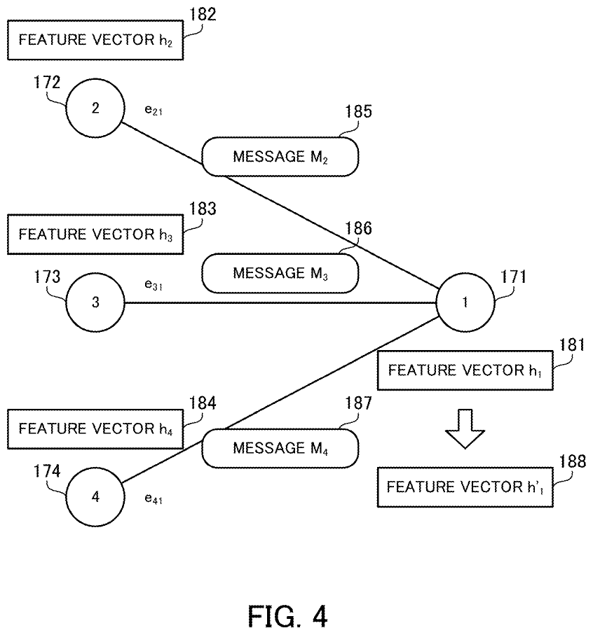

FIG. 4 illustrates an update example of a feature vector based on a graph structure.

Nodes 171, 172, 173, and 174 are included in the graph data 161, and each node represents an atom. The node 171 has a feature vector 181. The node 172 has a feature vector 182. The node 173 has a feature vector 183. The node 174 has a feature vector 184. The neighboring nodes of the node 171 are the nodes 172, 173, and 174. In the calculation described below, the node 171 itself may be included as one of the neighboring nodes of the node 171. Hereinafter, updating of the feature vector 181 will be described.

The machine learning model 162 calculates a message 185 from the feature vector 182 and the edge vector of the edge between the nodes 171 and 172, by using a message function. The machine learning model 162 calculates a message 186 from the feature vector 183 and the edge vector of the edge between the nodes 171 and 173, by using a message function. The machine learning model 162 calculates a message 187 from the feature vector 184 and the edge vector of the edge between the nodes 171 and 174, by using a message function. The individual message function includes a parameter value determined through machine learning.

The machine learning model 162 calculates a message by adding up the messages 185, 186, and 187. The machine learning model 162 updates the feature vector 181 to a feature vector 188 from the feature vector 181 and the resultant message, by using an update function. The update function includes a parameter value determined through machine learning. The machine learning model 162 executes the transmitting of messages and the updating of a feature vector for all the nodes. In addition, the machine learning model 162 executes this transmitting and this updating a plurality of times.

The machine learning model 162 is, for example, a polarizable atom interaction neural network (PaiNN). For example, PaiNN is described in the following literature. Kristof Schutt, Oliver Unke and Michael Gastegger, “Equivariant Message Passing for the Prediction of Tensorial Properties and Molecular Spectra”, Proc. of the 38th International Conference on Machine Learning (ICML 2021), Volume 139, pp. 9377-9388, July 2021.

The machine learning model 162 assigns feature vectors s and v to each node. For example, the feature vectors s and v are each a 128-dimensional numerical vector. A feature vector sᵢ represents the residual scalar of an i-th node. A feature vector vᵢ represents the equivariant representation of the i-th node. The initial value of the feature vector sᵢ is a distributed representation (embedded representation) transformed from an i-th nuclear charge Zᵢ. Normally, close nuclear charges are transformed into similar distributed representations. The part corresponding to the transformation to the distributed representation may be trained in advance or may be trained in combination with other parts in the machine learning model 162. The initial value of the feature vector vᵢ is a zero vector.

The machine learning model 162 updates the feature vector sᵢ of the node i in accordance with mathematical expression (1). In mathematical expression (1), Mₛ represents a message function about the feature vector s, and Uₛ represents an update function about the feature vector s. In addition, sⱼ represents the feature vector s of a node j that neighbors the node i, and rᵢⱼ represents an edge vector that indicates the distance and the direction from the coordinates of the node i to the coordinates of the node j. In addition, m_{s,i} represents a message that the node i receives from the neighboring node about the feature vector s.

$${m}_{s , i} = {\sum }_{j} {M}_{s} ( {s}_{j} , {r}_{ij} ) , {s}_{i} = {U}_{s} ( {s}_{i} , {m}_{s , i} ) \qquad ( 1 )$$

The message function Mₛ may include, as parameters, a coefficient matrix that affects the feature vector sⱼ and a coefficient matrix that affects the edge vector rᵢⱼ. The update function Uₛ may include, as parameters, a coefficient matrix that affects the feature vector sᵢ, and a coefficient matrix that affects the message m_{s,i}. Each of these edge vector rᵢⱼ and message m_{s,i} is, for example, a 128-dimensional numerical vector.

The machine learning model 162 updates the feature vector vᵢ of the node i in accordance with mathematical expression (2). In mathematical expression (2), Mᵥ represents a message function about the feature vector v, and Uᵥ represents an update function about the feature vectors v. In addition, vⱼ represents the feature vector v of the node j that neighbors the node i, and m_{v,i} represents a message that the node i receives from the neighboring node about the feature vector v.

$${m}_{v , i} = {\sum }_{j} {M}_{v} ( {v}_{j} , {s}_{j} , {r}_{ij} ) , {v}_{i} = {U}_{v} ( {v}_{i} , {m}_{v , i} ) \qquad ( 2 )$$

The message function Mᵥ may include, as parameters, a coefficient matrix that affects the feature vector vⱼ, a coefficient matrix that affects the feature vector sⱼ, and a coefficient matrix that affects the edge vector rᵢⱼ. The update function Uᵥ may include, as parameters, a coefficient matrix that affects the feature vector vᵢ, and a coefficient matrix that affects the message m_{v,i}. The message m_{v,i} is, for example, a 128-dimensional numerical vector.

The machine learning model 162 updates the feature vectors s and v of each node a plurality of times in accordance with mathematical expressions (1) and (2). Next, the machine learning model 162 executes linear transformation on the feature vector s of each of the plurality of nodes. For the linear transformation, a parameter value determined through machine learning is used. For example, a coefficient matrix that affects the feature vector s is used for the linear transformation. The machine learning model 162 aggregates the feature vectors s of all the nodes, the feature vectors s having been obtained after the linear transformation, to transform the feature vectors s into the prediction result 163 indicating energy.

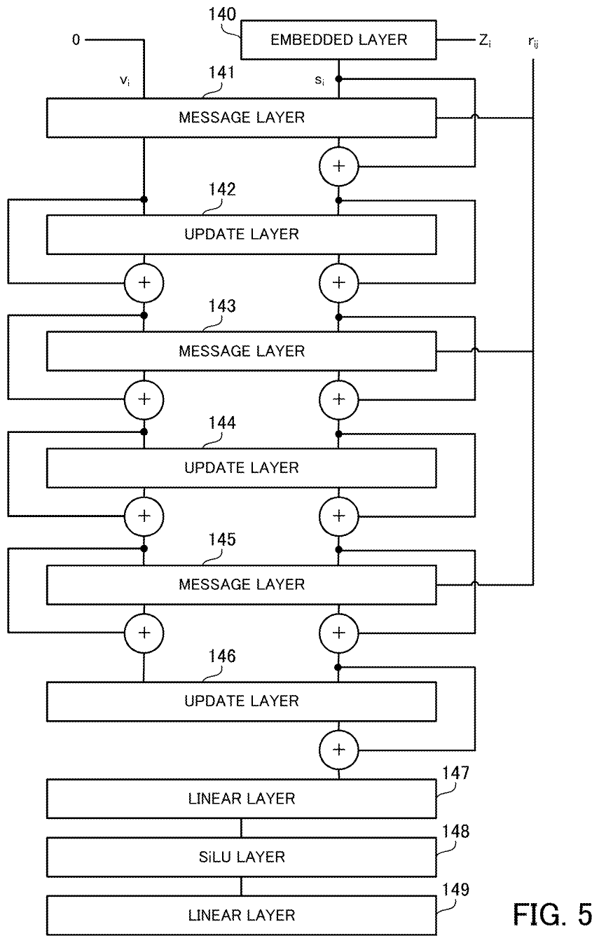

FIG. 5 illustrates a structure example of the machine learning model.

The machine learning model 162 includes an embedded layer 140, message layers 141, 143, and 145, update layers 142, 144, and 146, linear layers 147 and 149, and a sigmoid linear unit (SiLU) layer 148. The embedded layer 140 is a neural network that transforms the nuclear charge Zᵢ into a distributed representation vector of a certain number of dimensions. This distributed representation vector is the initial value of the feature vector sᵢ. The initial value of the feature vector vᵢ is a zero vector.

The message layer 141 receives the initial value of the feature vector sᵢ, the initial value of the feature vector vᵢ, and the edge vector rᵢⱼ indicated by the graph data 161. The message layer 141 executes processes based on the message functions Mₛ and Mᵥ, to transform the feature vectors sᵢ and vᵢ. For the transformation of the feature vectors sᵢ and vᵢ, the feature vector of an individual neighboring node is used. The feature vector sᵢ entered to the message layer 141 is added to the output of the message layer 141 about the feature vector sᵢ. In this way, training is executed such that the message layer 141 calculates an appropriate difference about the feature vector sᵢ.

The update layer 142 is located downstream of the message layer 141, and receives the feature vectors sᵢ and vᵢ, which have been updated through the message layer 141. The update layer 142 executes processes based on the update functions Uₛ and Uᵥ, to transform the feature vectors sᵢ and vᵢ. This transformation of the feature vectors sᵢ and vᵢ is executed per node, and the feature vector of the individual neighboring node is not used. The feature vector sᵢ entered to the update layer 142 is added to the output of the update layer 142 about the feature vector sᵢ. In addition, the feature vector vᵢ entered to the update layer 142 is added to the output of the update layer 142 about the feature vector vᵢ. In this way, training is executed such that the update layer 142 calculates an appropriate difference about the feature vectors sᵢ and vᵢ.

The message layer 143 is located downstream of the update layer 142, and receives the feature vectors sᵢ and vᵢ, which have been updated through the update layer 142, and the edge vector rᵢⱼ. The message layer 143 executes processes based on the message functions Mₛ and Mᵥ, to transform the feature vectors sᵢ and vᵢ. The feature vectors sᵢ and vᵢ entered to the message layer 143 are added to the output of the message layer 143 about the feature vectors sᵢ and vᵢ, respectively.

The update layer 144 is located downstream of the message layer 143, and receives the feature vectors sᵢ and vᵢ, which have been updated through the message layer 143. The update layer 144 executes processes based on the update functions Uₛ and Uᵥ, to transform the feature vectors sᵢ and vᵢ. The feature vectors sᵢ and vᵢ entered to the update layer 144 are added to the output of the update layer 144 about the feature vectors sᵢ and vᵢ, respectively.

The message layer 145 is located downstream of the update layer 144, and receives the feature vectors sᵢ and vᵢ, which have been updated through the update layer 144, and the edge vector rᵢⱼ. The message layer 145 executes processes based on the message functions Mₛ and Mᵥ, to transform the feature vectors sᵢ and vᵢ. The feature vectors sᵢ and vᵢ entered to the message layer 145 are added to the output of the message layer 145 about the feature vectors sᵢ and vᵢ, respectively.

The update layer 146 is located downstream of the message layer 145, and receives the feature vectors sᵢ and vᵢ, which have been updated through the message layer 145. The update layer 146 executes processes based on the update functions Uₛ and Uᵥ, to transform the feature vectors sᵢ and vᵢ. The feature vector sᵢ entered to the update layer 146 is added to the output of the update layer 146 about the feature vector sᵢ.

Although the message layers 141, 143, and 145 using the message functions Mₛ and Mᵥ include the same kind of parameters, training may be executed such that the parameters have different parameter values. In addition, although the update layers 142, 144, and 146 using the update functions Uₛ and Uᵥ include the same kind of parameters, training may be executed such that the parameters have different parameter values.

The linear layer 147 is located downstream of the update layer 146, and receives the feature vector sᵢ, which has been updated through the update layer 146. The linear layer 147 executes linear transformation on the feature vector sᵢ by using a coefficient matrix. This linear transformation is executed per node.

The SiLU layer 148 is located downstream of the linear layer 147, and receives the feature vector from the linear layer 147. The SiLU layer 148 uses SiLU indicated in mathematical expression (3), to transform each dimension of numerical value included in the feature vector. SiLU is a kind of activation function, and may be referred to as “Swish function”.

$$SiLU ( x ) = x * \frac{1}{1 + exp ( - x )} \qquad ( 3 )$$

The linear layer 149 is located downstream of the SiLU layer 148, and receives the feature vector from the SiLU layer 148. The linear layer 149 uses a coefficient matrix to execute linear transformation on the feature vector. This linear transformation is executed per node. The feature vectors of the plurality of nodes outputted by the linear layer 149 are aggregated and finally transformed into the prediction result 163.

Next, machine learning for training the machine learning model 162 will be described.

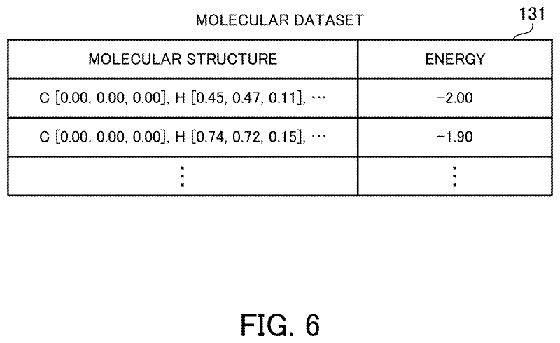

FIG. 6 illustrates a structure example of a molecular dataset.

The information processing apparatus 100 stores a molecular dataset 131. The information processing apparatus 100 includes a plurality of samples usable for machine learning. Each sample indicates a molecular structure and energy. The individual molecular structure represents the coordinates of the locations of the plurality of atoms included in a molecule and the elements, which indicate the kinds of the atoms. The nuclear charges are calculated from their respective elements. The molecular structures correspond to the explanatory variables or input data of the machine learning model 162. The energy is molecular ground state energy. The energy corresponds to the objective variables or correct labels of the machine learning model 162.

As will be described below, the information processing apparatus 100 selects, from the molecular dataset 131, some samples useful in improving the prediction accuracy of the machine learning model 162, and trains the machine learning model 162 by using the selected samples. The samples that have not been selected may be unused for the training of the machine learning model 162. Each sample may be with or without a correct label at the sample selection. In the latter case, the information processing apparatus 100 may request the user to assign a correct label to a selected sample.

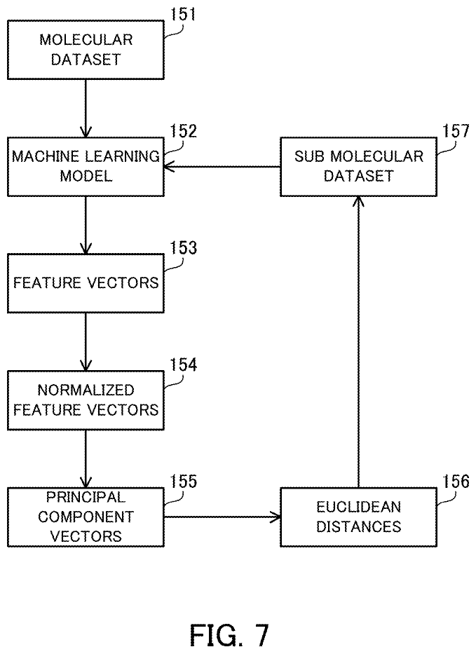

FIG. 7 illustrates an example of sample selection in machine learning.

The information processing apparatus 100 acquires a molecular dataset 151 including a plurality of samples. The molecular dataset 151 corresponds to the above-described molecular dataset 131. The information processing apparatus 100 predicts the energy for each of the plurality of samples included in the molecular dataset 151 by using a machine learning model 152. The machine learning model 152 corresponds to the above-described machine learning model 162. The machine learning model 152 has been temporarily trained in advance. For example, the machine learning model 152 has been trained in advance by using a small number of samples. At this point, the prediction accuracy of the machine learning model 152 does not have to be high.

The information processing apparatus 100 extracts, per sample, feature vectors calculated in the machine learning model 152 in the process of predicting energy from the machine learning model 152. The extracted feature vectors are the feature vectors that have passed through a graph neural network, and are the feature vectors of a plurality of atoms that have not been aggregated yet. In the second embodiment, the information processing apparatus 100 extracts the feature vectors that are entered to the linear layer 147 illustrated in FIG. 5.

The information processing apparatus 100 generates a feature vector 153 per sample, by connecting the plurality of feature vectors of the plurality of atoms. If a molecule in the molecular dataset 131 is a large-scale molecule, the feature vector 153 could have tens of thousands of dimensions.

The information processing apparatus 100 normalizes the feature vectors 153 of the plurality of samples to normalized feature vectors 154. In the normalization, the information processing apparatus 100 determines a maximum value and a minimum value for each of the dimensions of the feature vectors 153, and transforms the scale of the numerical value range from the minimum value to the maximum value to a numerical value range between 0 and 1, inclusive. This normalization is executed in accordance with mathematical expression (4), in which x is a variable representing a certain dimension, and max(x) and min(x) represent a maximum value and a minimum value of the dimension x of the plurality of feature vectors of the plurality of samples.

$$normalize ( x ) = \frac{x - min ( x )}{max ( x ) - min ( x )} \qquad ( 4 )$$

The information processing apparatus 100 executes principal component analysis on the plurality of normalized features vectors of the plurality of samples, to transform the normalized feature vectors 154 to principal component vectors 155. As a result, a plurality of principal component vectors of the plurality of samples are generated. The principal component vectors 155 are numerical vectors of which the number of dimensions is less than that of the normalized feature vectors 154.

In the principal component analysis, the information processing apparatus 100 generates a variance-covariance matrix from the plurality of normalized features vectors of the plurality of samples, and executes eigenvalue decomposition on the variance-covariance matrix. In the eigenvalue decomposition, an eigenvalue λ and an eigenvector v satisfying Av=λv are obtained for a certain matrix A. With this eigenvector v, a new coordinate axis is determined in the vector space. This coordinate axis is a coordinate axis indicating a large dispersion in the vector space, and represents characteristics of the distribution of the samples.

The information processing apparatus 100 calculates a Euclidean distance 156 between the principal component vectors 155 of each pair of two different samples. Another distance index such as a cosine similarity may be alternatively used as the distance index. Based on the Euclidean distances 156, the information processing apparatus 100 extracts some samples from the molecular dataset 151, and generates a sub molecular dataset 157 formed by these extracted samples.

The number of extracted samples may be specified by the user. Alternatively, the number of extracted samples may be determined based on the number of samples in the molecular dataset 151. For example, the number of extracted samples may be 1/10 of the number of samples in the molecular dataset 151. The information processing apparatus 100 selects the samples to be included in the sub molecular dataset 157 such that the principal component vectors 155 of these samples are as dissimilar as possible to one another. Thus, samples whose principal component vectors 155 are similar to one another are not redundantly included as much as possible in the sub molecular dataset 157.

For example, the information processing apparatus 100 calculates, for each of the plurality of samples, the minimum value among the Euclidean distances 156 to the other samples (the Euclidean distance 156 to the closest one of the other samples). The information processing apparatus 100 preferentially excludes a sample having the minimum value among the plurality of samples. The information processing apparatus 100 repeats the sample exclusion until the number of remaining samples reaches a target sample number or less.

The information processing apparatus 100 may detect a pair of samples having a small Euclidean distance 156, and may exclude one or both of the detected samples. Based on the Euclidean distances 156, the information processing apparatus 100 may classify the plurality of principal component vectors of the plurality of samples into clusters, and may select representative samples from each cluster. The number of clusters may be the same as the target sample number. A clustering algorithm such as a k-means algorithm or hierarchical clustering may be used.

The information processing apparatus 100 further trains the machine learning model 152 by using the samples included in the sub molecular dataset 157. For example, the information processing apparatus 100 generates input data from a molecular structure indicated by a sample, and enters the generated input data to the machine learning model 152. The information processing apparatus 100 calculates the error between the energy predicted by the machine learning model 152 and the correct label indicated by the sample, and updates the parameter values included in the machine learning model 152 by executing backpropagation. As a result, the prediction accuracy of the machine learning model 152 improves from that of the machine learning model 152 temporarily trained.

The information processing apparatus 100 may repeat the cycle illustrate in FIG. 7 a plurality of times. In this case, the information processing apparatus 100 enters each of the plurality of samples included in the molecular dataset 151 to the machine learning model 152 trained by using the sub molecular dataset 157. The information processing apparatus 100 calculates the feature vectors 153, the normalized feature vectors 154, the principal component vectors 155, and the Euclidean distances 156. The information processing apparatus 100 extracts a new sub molecular dataset 157 from the molecular dataset 151.

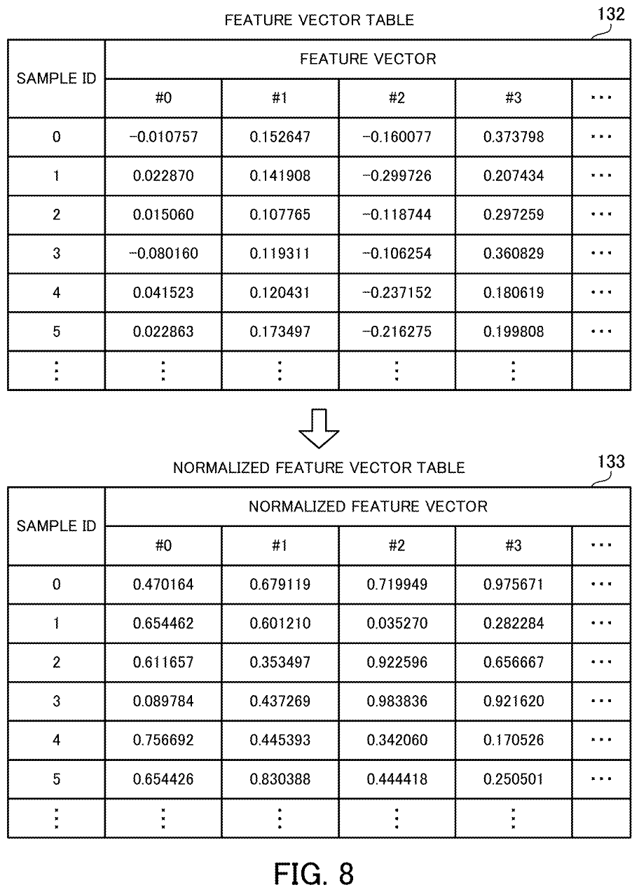

FIG. 8 illustrates an example of normalization of feature vectors.

The information processing apparatus 100 generates a feature vector table 132. The feature vector table 132 is a table in which a plurality of feature vectors corresponding to the above-described feature vectors 153 are listed for a plurality of samples. A single row in the feature vector table 132 represents a single feature vector of a single sample. The plurality of columns in the feature vector table 132 correspond to the plurality of dimensions of the individual feature vector. A single feature vector is obtained by connecting the plurality of feature vectors calculated for a plurality of atoms included in a sample. The connected feature vectors are extracted immediately before the linear layer 147 in FIG. 5.

The information processing apparatus 100 generates a normalized feature vector table 133 by executing normalization on the feature vector table 132. The information processing apparatus 100 determines, for each of the columns of the feature vector table 132, a maximum value and a minimum value, and determines a scale transformation function for transforming the numerical value range from the minimum value to the maximum value into a numerical value range from 0 to 1, inclusive. The information processing apparatus 100 executes, per column, the normalization by using the determined scale transformation function.

As described above, the information processing apparatus 100 extracts the feature vectors of the individual atoms that have passed through a graph neural network from a machine learning model. The data transformation in the graph neural network is a non-linear transformation. Thus, determining the similarity between samples from the corresponding feature vectors on which the non-linear transformation has been executed makes it possible to determine redundant samples that less contribute to improvement in prediction accuracy more easily than determining the similarity from the input data of the samples.

In addition, the information processing apparatus 100 normalizes the feature vectors extracted from the machine learning model before executing the principal component analysis. By normalizing the feature vectors, certain dimensions of the original feature vectors are prevented from becoming dominant in the principal component analysis. That is, all the dimensions included in the original feature vectors are sufficiently taken into account. Thus, the similarity determination accuracy is improved. As a result, samples useful in improving the prediction accuracy are selected.

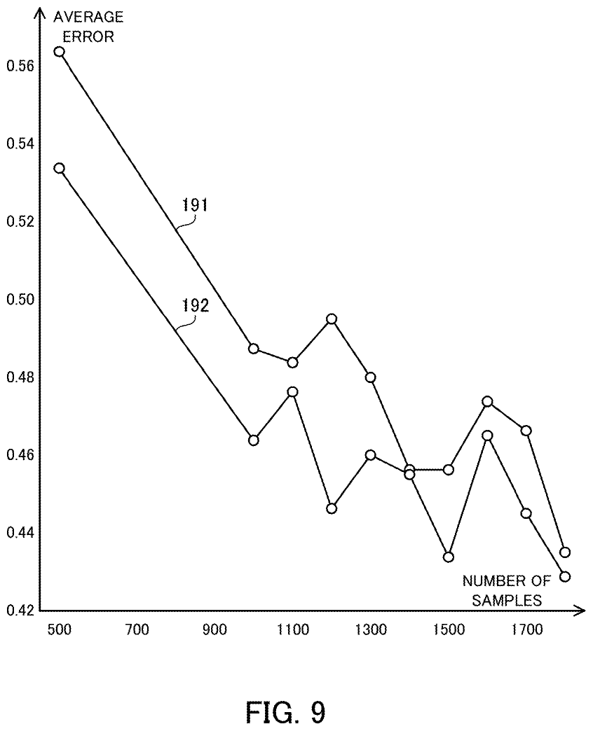

FIG. 9 is a graph illustrating examples of average errors of machine learning models.

Curves 191 and 192 each represent the relationship between the number of samples and an average error. The horizontal axis in FIG. 9 represents the number of samples, and the vertical axis in FIG. 9 represents the average error. The number of samples is the number of samples selected for machine learning from a population, and corresponds to the number of samples in the sub molecular dataset 157 in FIG. 7. Herein, the number of samples is specified by the user. The average error is the average of predicted errors, each of which is the error between energy predicted by a machine learning model and a corresponding correct label when the machine learning model is trained by using the selected samples.

The curve 191 represents an average error obtained when the feature vectors are not normalized before samples are selected from a population. The curve 192 represents an average error obtained when the feature vectors are normalized before samples are selected from a population. As illustrated by the curves 191 and 192, if the same number of samples are used, the case in which the feature vectors are normalized achieves a less average error than the case in which the feature vectors are not normalized. Thus, by normalizing the feature vectors, appropriate samples that contribute to improving the prediction accuracy of the machine learning model are selected, and the prediction accuracy is consequently improved.

In addition, the case in which the feature vectors are normalized achieves a desired prediction accuracy with a smaller number of samples than the case in which the feature vectors are not normalized. Thus, the load of the machine learning using selected samples is reduced, and the machine learning time is consequently shortened.

Next, functions and procedures of the information processing apparatus 100 will be described.

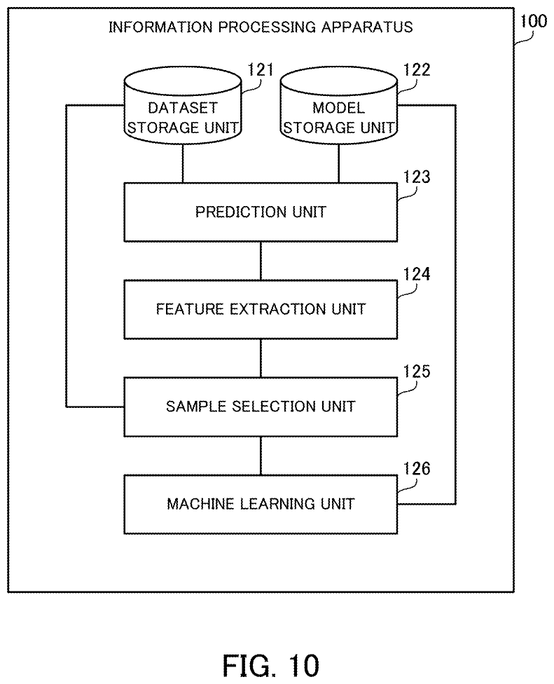

FIG. 10 is a block diagram illustrating a functional example of the information processing apparatus.

The information processing apparatus 100 includes a dataset storage unit 121, a model storage unit 122, a prediction unit 123, a feature extraction unit 124, a sample selection unit 125, and a machine learning unit 126. The dataset storage unit 121 and the model storage unit 122 are each implemented by using the RAM 102, a GPU memory, or the HDD 103, for example. The prediction unit 123, the feature extraction unit 124, the sample selection unit 125, and the machine learning unit 126 are each implemented by using the CPU 101, the GPU 104, and a program, for example.

The dataset storage unit 121 stores a plurality of samples as a population. For example, the dataset storage unit 121 stores the above-described molecular dataset 131. Each sample includes a molecular structure and energy. The energy is a correct label corresponding to a correct answer compared with the output of a machine learning model. As in active learning, a correct label may be given to a sample after use of the sample for the machine learning is determined.

The model storage unit 122 stores a machine learning model. For example, the model storage unit 122 stores the machine learning model 162 illustrated in FIG. 5. The machine learning model has been temporarily trained in advance. This machine learning model is further trained by using some of the plurality of samples stored in the dataset storage unit 121.

For each of the plurality of samples stored in the dataset storage unit 121, the prediction unit 123 generates input data suitable for the input format of the machine learning model from the molecular structure defined in the corresponding sample. The prediction unit 123 enters the generated input data about each of the plurality of samples to the machine learning model and predicts the molecule energy.

For each of the plurality of samples, the feature extraction unit 124 extracts a feature vector, which is calculated while the prediction unit 123 is predicting the corresponding energy, from the machine learning model. An extracted feature vector is calculated for each of the atoms included in a molecule and is obtained after the message propagation among the atoms is sufficiently executed. If the machine learning model includes a message layer and an update layer alternately, the individual extracted feature vector is a feature vector updated by the last update layer, for example. The feature extraction unit 124 connects the plurality of feature vectors of the plurality of atoms, to acquire a single feature vector per sample.

The sample selection unit 125 selects some of the samples from the dataset storage unit 121, based on the feature vectors acquired by the feature extraction unit 124. First, the sample selection unit 125 normalizes a plurality of feature vectors of a plurality of samples, and generates a plurality of normalized feature vectors of the plurality of samples. The sample selection unit 125 executes principal component analysis on the plurality of normalized features vectors, and generates a plurality of principal component vectors of the plurality of samples. The sample selection unit 125 calculates a Euclidean distance indicating the similarity between the principal component vectors of two different samples.

The sample selection unit 125 selects some of the samples from the dataset storage unit 121, based on the Euclidean distances. The sample selection unit 125 selects samples whose Euclidean distance is as large as possible to the other samples. For example, between two samples whose Euclidean distance is small, the sample selection unit 125 excludes one or both of the samples from the sample population. Thus, the redundant samples whose principal component vector is similar are excluded.

The machine learning unit 126 trains the machine learning model by using the samples selected by the sample selection unit 125. The samples that have not been selected by the sample selection unit 125 are not used for the machine learning. For example, from the molecular structure defined by a sample, the machine learning unit 126 generates input data suitable for the input format of the machine learning model, and enters the input data to the machine learning model. The machine learning unit 126 calculates the error between the predicted data outputted by the machine learning model and the corresponding correct label, and updates the parameter values such that the error will be minimized.

The machine learning unit 126 may update the parameter values included in the machine learning model by executing backpropagation. The machine learning unit 126 may divide the plurality of selected samples into a plurality of mini batches, and may repeat the forward process of calculating the error and the backward process of updating the parameter values, by using these plurality of mini batches.

The information processing apparatus 100 may output information about the selected samples. The information processing apparatus 100 may store the information about the selected samples in a non-volatile storage, may display the information about the selected samples on the display device 111, or may transmit the information about the selected samples to another information processing apparatus. The information processing apparatus 100 may store the trained machine learning model in a non-volatile storage, may display the trained machine learning model on the display device 111, or may transmit the trained machine learning model to another information processing apparatus.

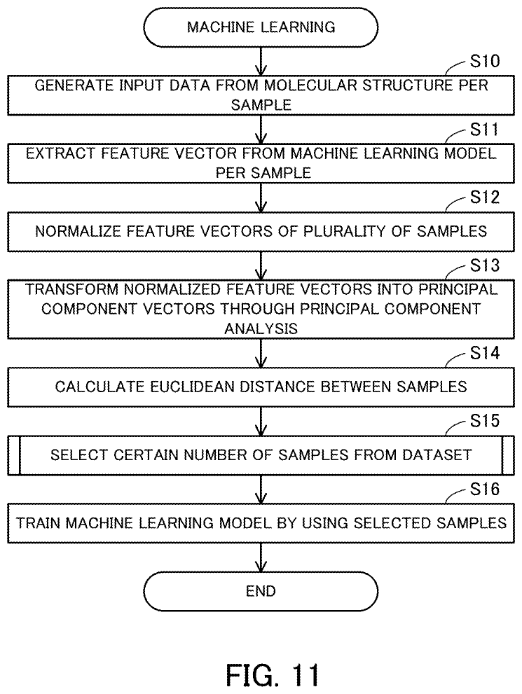

FIG. 11 is a flowchart illustrating a procedure example of the machine learning.

(S10) The prediction unit 123 generates input data from a molecular structure per sample.

(S11) The prediction unit 123 enters the input data to a machine learning model per sample, and executes the forward process of generating predicted data. The feature extraction unit 124 extracts a feature vector from the machine learning model per sample. The extracted feature vector is a feature vector generated in the process of the transforming the input data into the predicted data.

(S12) The sample selection unit 125 normalizes the feature vectors of the plurality of samples. In this normalization, scale adjustment is executed such that the numerical values of the individual feature vectors fall within a certain range per dimension.

(S13) The sample selection unit 125 executes principal component analysis on the normalized feature vectors of the plurality of samples, so as to transform the normalized feature vectors into principal component vectors.

(S14) The sample selection unit 125 calculates the Euclidean distance between the principal component vectors of each pair of two different samples of the plurality of samples.

(S15) The sample selection unit 125 selects a certain number of samples from the population dataset, based on the Euclidean distances calculated in step S14. For example, the number of samples selected is specified by the user. A sample having a greater Euclidean distance from the other samples is preferentially selected. The sample selection will be described below.

(S16) The machine learning unit 126 trains the machine learning model by using the samples selected in step S15. For example, the machine learning unit 126 enters the input data to the machine learning model per sample, and calculates the error between the predicted data outputted by the machine learning model and the corresponding correct label. The machine learning unit 126 updates the parameter values included in the machine learning model by executing backpropagation such that the error will be minimized.

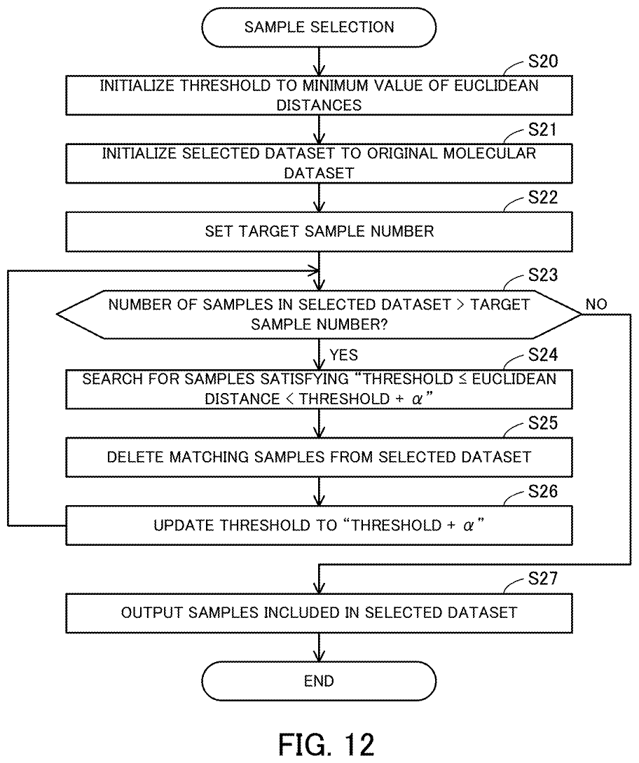

FIG. 12 is a flowchart illustrating a procedure example of the sample selection.

The sample selection is executed in step S15 in FIG. 11.

(S20) The sample selection unit 125 initializes a threshold to a minimum value of the Euclidean distances comprehensively calculated in step S14.

(S21) The sample selection unit 125 initializes the selected dataset indicating the selected samples to the original molecular dataset used as the population. Thus, the selected dataset in the initial state indicates that all the samples have been selected.

(S22) The sample selection unit 125 sets a target sample number. The target sample number is the upper limit of the number of samples selected. The target sample number may be specified by the user or may be determined based on the number of population samples.

(S23) The sample selection unit 125 determines whether the number of samples included in the selected dataset exceeds the target sample number. If the number of samples included in the selected dataset exceeds the target sample number, the process proceeds to step S24. If the number of samples included in the selected dataset is equal to or less than the target sample number, the process proceeds to step S27.

(S24) The sample selection unit 125 searches the selected dataset for samples whose Euclidean distance is the threshold or more and is less than “threshold+α”. For example, α=0.01.

For example, the sample selection unit 125 searches for a sample whose Euclidean distance to another sample closest thereto satisfies the above-described range (searches for a sample having the minimum Euclidean distance to another sample). The matching sample is to be deleted in step S25. For example, the sample selection unit 125 searches for a pair of samples whose Euclidean distance satisfies the above-described range. If there is such a pair of samples, one or both of the samples are to be deleted in step S25.

(S25) If there are samples that satisfy the condition in step S24, the sample selection unit 125 deletes the matching samples from the selected dataset.

(S26) The sample selection unit 125 updates the threshold to “threshold+α”. For example, the sample selection unit 125 adds 0.01 to the threshold. Next, the process returns to step S23.

(S27) The sample selection unit 125 outputs the samples included in the selected dataset as the samples to be used for the machine learning.

As described above, the information processing apparatus 100 according to the second embodiment uses a machine learning model to predict the result of a quantum chemical calculation using the density functional theory, instead of actually executing the quantum chemical calculation. As a result, the load of the quantum chemical simulation is reduced, and the simulation time is consequently shortened. The machine learning model includes a graph neural network. In this way, the feature vectors of the individual atoms are calculated in view of a molecular structure, and the prediction accuracy is improved.

In addition, instead of using all the samples included in the population, only some of the samples are used for the machine learning. In this way, the load of the machine learning is reduced, and the machine learning time is consequently shortened. In addition, because the information processing apparatus 100 uses selected samples, instead of using all the miscellaneous samples including similar and redundant samples, the information processing apparatus 100 acquires a trained machine learning model having improved prediction accuracy.

In addition, when samples are entered to a machine learning model, the information processing apparatus 100 determines the similarity between an individual pair of samples by using feature vectors calculated inside the machine learning model. The information processing apparatus 100 selects samples as dissimilar as possible to one another. In this way, redundant samples are excluded, and samples that greatly contribute to improving the prediction accuracy of the machine learning model are selected. Thus, assuming that the same number of samples are selected, the machine learning model achieves a better prediction accuracy. In addition, a target prediction accuracy is achieved with a small number of samples, and the machine learning time is shortened.

In addition, the information processing apparatus 100 determines the similarity between samples by using the feature vectors of the corresponding atoms. These feature vectors are those that have passed through the non-linear transformation in the graph neural network and that have not been aggregated yet. In this way, the similarity is determined based on the feature vectors strongly related to a prediction result of the machine learning model, and the accuracy in sample selection is improved.

In addition, the information processing apparatus 100 normalizes the feature vectors extracted from the machine learning model into normalized feature vectors, and executes principal component analysis to transform the normalized feature vectors into principal component vectors. Through this normalization, the plurality of dimensions of the feature vectors are represented by a unified scale. In this way, the risk that some of the dimensions of the features become dominant and other dimensions are underestimated is reduced, and principal component vectors appropriately expressing the features of the individual samples are generated. By executing the principal component analysis, principal component vectors suitable for determining the inter-sample similarity are generated.

In one aspect, the prediction accuracy of a machine learning model is improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
entering a plurality of data samples individually to a machine learning model and extracting a plurality of features of each of the data samples from the machine learning model;
normalizing the plurality of features to a plurality of normalized features that fall within a certain numerical value range;
selecting, based on the plurality of normalized features, at least one data sample, which is part of the plurality of data samples, from the plurality of data samples; and
training the machine learning model by using the at least one data sample.

2. The non-transitory computer-readable recording medium according to claim 1,
wherein the machine learning model includes a graph neural network that updates, based on a connection relationship among a plurality of nodes indicated by graph data, a feature of each of the plurality of nodes, and
wherein the plurality of features are features that have passed through the graph neural network.

3. The non-transitory computer-readable recording medium according to claim 1, wherein the selecting includes transforming the plurality of normalized features into a plurality of principal component features by executing principal component analysis, and selecting the at least one data sample, based on a distance between an individual pair of the plurality of principal component features.

4. The non-transitory computer-readable recording medium according to claim 1,
wherein the machine learning model predicts molecular energy from molecular data indicating a molecule including a plurality of atoms, and
wherein the plurality of features are features calculated for the plurality of atoms.

5. A machine learning method comprising:
entering, by a processor, a plurality of data samples individually to a machine learning model and extracting a plurality of features of each of the data samples from the machine learning model;
normalizing, by the processor, the plurality of features to a plurality of normalized features that fall within a certain numerical value range;
selecting, by the processor, based on the plurality of normalized features, at least one data sample, which is part of the plurality of data samples, from the plurality of data samples; and
training, by the processor, the machine learning model by using the at least one data sample.

6. An information processing apparatus comprising:
a memory configured to store a plurality of data samples and a machine learning model; and
a processor coupled to the memory and the processor configured to execute a process including:
entering the plurality of data samples individually to the machine learning model,
extracting a plurality of features of each of the data samples from the machine learning model,
normalizing the plurality of features to a plurality of normalized features that fall within a certain numerical value range,
selecting, based on the plurality of normalized features, at least one data sample, which is part of the plurality of data samples, from the plurality of data samples, and
training the machine learning model by using the at least one data sample.
